(19) United States
(12) Patent Application Publication
(10) Pub. No.: US 2011/0320595 A1
(43) Pub. Date: Dec. 29, 2011

(54) MEDICAL INFORMATION PROCESSING DEVICE AND SOFTWARE DISTRIBUTING SYSTEM

(75) Inventors: Hayato KONISHI, Nasushiobara-shi (JP); Kousuke Sakaue, Nasushiobara-shi (JP); Junichi Tashiro, Otawara-shi (JP)

(73) Assignees: TOSHIBA MEDICAL SYSTEMS CORPORATION, Otawara-shi (JP); Kabushiki Kaisha Toshiba, Tokyo (JP)

(21) Appl. No.: 13/166,104

(22) Filed: Jun. 22, 2011

(30) Foreign Application Priority Data
Jun. 25, 2010 (JP) 2010-145006

(51) Int. Cl. G06F 15/173

(52) U.S. Cl. 709/224

(57) ABSTRACT

This embodiment involves a medical information processing device comprising: a storage part; a configuration information storage part; a determination part; and a controller. The storage part stores a plurality of application programs. The configuration information storage part stores configuration information for an execution environment that is quality guaranteed, corresponding to the application program. The determination part, based on the configuration information, determines whether it is possible to run the application program. The controller, if it is determined at the determination part that the application program cannot be run, causes a function corresponding to this application program to be run on a server.

### CROSS-REFERENCE TO RELATED APPLICATION

This application is based upon and claims the benefit of priority from Japanese Patent Application No. 2010-145006, filed Jun. 25, 2010; the entire contents of which are incorporated herein by reference.

### FIELD

The present invention relates to a technology that distributes software in an environment in which a plurality of medical systems co-exists.

In an environment in which the plurality of medical systems co-exist, there are cases in which a plurality of software are installed to terminals (hereinafter referred to as “clients”) in order to operate. When functions are added or modified to these types of software, this is performed by newly updating the software, with these software updates being managed by versions. It is required that the software update be performed promptly and effectively, and in recent years, a method in which software is stored in a server and distributed to the clients is widely used. Note that the application programs are included in this software. Moreover, not only may this software include application programs, it may also include drivers for controlling hardware, etc.

Moreover, not only are there cases in which the software operates alone, there are also cases in which the plurality of software operate in conjunction with one another. Such cases include, for example, cases in which they operate in conjunction with one another, resulting from transmission and reception of data between the plurality of software, or resulting from calling up each other's processing. In such cases, operation verification of the respective software operating in conjunction with one another is performed, and should there be any problems, version upgrade is performed for the respective software each time there are problems. The environment in which an action is ultimately verified with this operation verification, that is, the environment under which it operates with a combination of software operating in conjunction with one another and the version thereof (hereinafter referred to as a “software configuration”) is referred to as the environment that is quality guaranteed. As the respective software is installed to the client with the same software configuration as the environment that is quality guaranteed, it is possible to safely operate the respective software operating in conjunction with one another at the client.

However, this does not mean that the respective software operating in conjunction with one another is installed to the clients with the same software configuration as the environment that is quality guaranteed. For example, among the plurality of software operating in conjunction with one another, there are cases in which the installation of some software fails and the software installed to the client is not updated to the new version software.

Even for software configuration, which is different from the environment that is quality guaranteed, there are cases in which it is possible to use some functions. Specifically, for example, during installation of some software, among the software operating in conjunction with one another, even if other software operating in conjunction with one another is run, the software may operate with the software configuration, which is different from the environment that is quality guaranteed. In such cases, the function is not always performed properly. Particularly, in medical systems, small malfunctions or operation mistakes may develop into major problems.

### BRIEF DESCRIPTION OF THE DRAWINGS

FIG. 1 is a functional block diagram of a software distributing system according to a first embodiment.

FIG. 2 is a figure for explaining the data structure of the configuration management information.

FIG. 3 is a figure for explaining a case in which software that is related to one software configuration is installed, and a disapproval-software detection part monitors operation of software.

FIG. 4 is a figure for explaining a case in which software that is related to a plurality of software configurations is installed, and a disapproval-software detection part monitors operation of software.

FIG. 5 is a flowchart for explaining processing registration of configuration management information, and processing extraction of configuration management information based on software configuration of a client in the software distributing system according to the first embodiment.

FIG. 6 is a flowchart for explaining processing installation of respective software to a client based on configuration management information in the software distributing system according to the first embodiment and a modified example.

FIG. 7 is a flowchart for explaining the action of the disapproval-software detection part in the software distributing system according to the first embodiment and a modified example.

FIG. 8 is a flow chart for explaining processing for cases in which the disapproval-software detection part detects the action of the software subjected to the monitoring in the software distributing system according to the first embodiment.

FIG. 9 is a functional block diagram of a software distributing system according to the modified example.

FIG. 10 is a flow chart for explaining the association of the configuration management information with connection destination information.

FIG. 11 is a flowchart for explaining processing registration of configuration management information, and processing extraction of configuration management information based on software configuration of a client in the software distributing system according to the modified example.

FIG. 12 is a flow chart for explaining processing for cases in which the disapproval-software detection part detects the action of the software subjected to the monitoring in the software distributing system according to the modified example.

FIG. 13 is a functional block diagram showing one aspect of the software distributing system according to the modified example.

FIG. 14 is a functional block diagram showing one aspect of the software distributing system according to the modified example.

### DETAILED DESCRIPTION

The object of the embodiments of the present invention is to solve the above problems, and for cases in which the software installed to the client is to be updated, including the plurality of software operating in conjunction with software that is subjected to the update, it is intended to update and control such that the same software configuration as the environment that is quality guaranteed is obtained.

In order to achieve the above object, the first aspect of the embodiment involves a medical information processing device that is constituted from a storage part; a configuration information storage part; a determination part; and a controller. The storage part stores a plurality of application programs. The configuration information storage part stores configuration information for an execution environment that is quality guaranteed, corresponding to the application program. The determination part, based on the configuration information, determines whether it is possible to run the application program. The controller, if it is determined at the determination part that it is not possible to run the application program, causes a function corresponding to this application program to be run on a server.

Moreover, the second aspect of the embodiment involves a software distributing system that is constituted from a plurality of terminals; and a server that distributes software to the terminals. The server is constituted from a storage part and a configuration information storage part. The storage part stores a plurality of application programs. The configuration information storage part stores configuration information for an execution environment that is quality guaranteed, corresponding to the application program. The terminals are constituted from an acquisition part; a determination part; and a controller. The acquisition part acquires an installation program for updating the application program and the configuration information corresponding to the application program, through a network from the server. The determination part, based on the configuration information, determines whether it is possible to run the application program. The controller, if it is determined at the determination part that the application program cannot be run, causes a function corresponding to this application program to be run on the server.

### First Embodiment

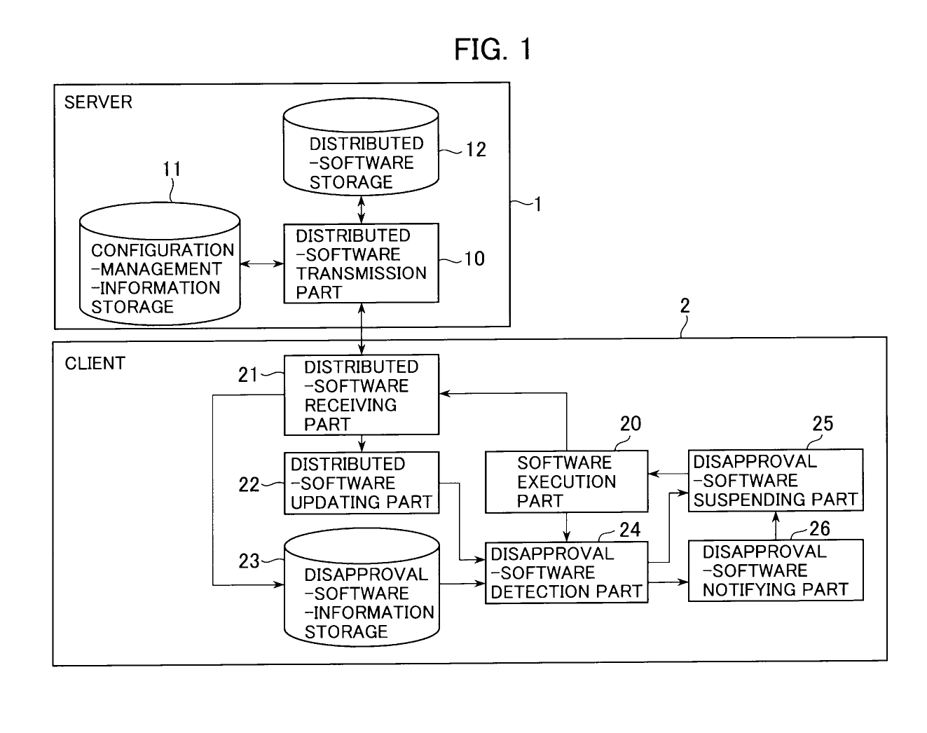

First, the configuration of the software distributing system according to the first embodiment is explained with reference to FIG. 1. The software distributing system according to the present embodiment is constituted from a server 1; and a client 2.

The server 1 includes configuration-management-information storage 11; distributed-software storage 12; and a distributed-software transmission part 10. Moreover, the client 2 includes a distributed-software receiving part 21; disapproval-software-information storage 23; a distributed-software updating part 22; a software execution part 20; a disapproval-software detection part 24; a disapproval-software notifying part 26; and a disapproval-software suspending part 25. Each configuration is described in detail below.

First, each configuration of the server 1 is explained in detail.

The distributed-software storage 12 is a memory area that stores respective software to be distributed to the client by version. For example, as software, namely “a.exe”, when there are software in version 1.0 and version 1.0.2, the a.exe in version 1.0 and the a.exe in version 1.0.2 are stored in the distributed-software storage 12, by identifying them respectively, making sure they are read out.

At this time, the distributed-software storage 12 includes respective software by version, and it may be constituted such that an installer for installing the software to the client is stored. Note that if the software to be installed itself is stored, it may be constituted such that the environment for installing the software to the client (the environment that serves as the base, which is generally referred to as a framework) is established. Hereinafter, an explanation is provided, assuming that the installer of the respective software by version is stored in the distributed-software storage 12. Note that the distributed-software storage 12 corresponds to the “storage part.”

The configuration-management-information storage 11 is a memory area for registering and storing the configuration management information. The configuration management information is explained below.

The configuration management information, with regard to the plurality of software operating in conjunction with one another, associates and defines the combination of the version of the respective software before the update (hereinafter may be referred to as a “pre-update version”) and the combination of the version of the respective software subjected to the update (hereinafter may be referred to as a “version subjected to the update”) with the information for identifying the respective software. That is, for the configuration management information, the information for updating the environment in which the respective software operates with the combination of the pre-update version (the client 2) up to the environment in which the respective software operates with the combination of the version subjected to the update is defined.

Note that for the information identifying the respective software, for example, software names, execution file names, etc., are applicable. Below, the information identifying the respective software is referred to as “software identification information.” Moreover, the pre-update version corresponds to the “current version,” and the version subjected to update corresponds to the “latest version.” Moreover, the pre-update version and the version subjected to the update correspond to “version information.”

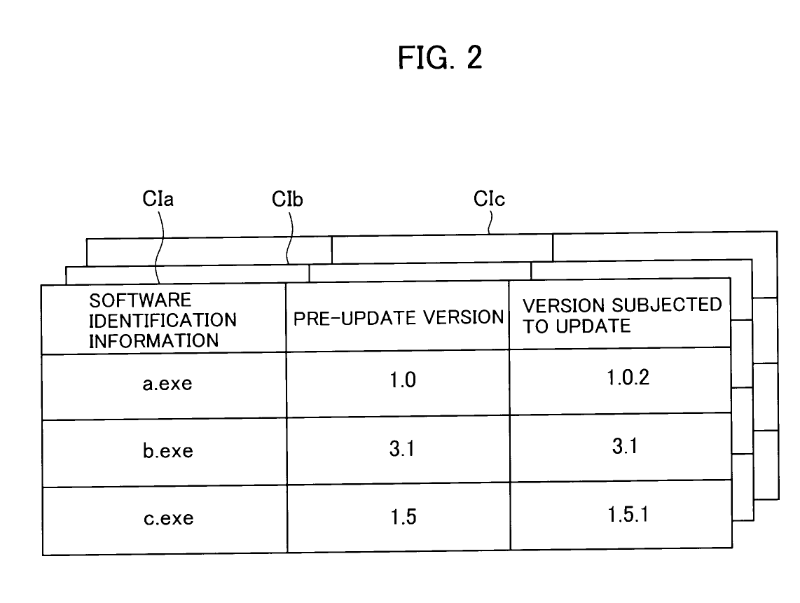

FIG. 2 is a figure for explaining the data structure of the configuration management information. The configuration management information is stored in the configuration-management-information storage 11 by the respective software configuration operating in conjunction with one another. In the example in FIG. 2, for the respective software configuration operating in conjunction with one another, it is managed as configuration management information CIa, CIb, and CIc. For example, the configuration management information CIa indicates that software “a.exe”, “b.exe”, and “c.exe” are software operating in conjunction with each other. Specifically, for the configuration management information CIa, with respect to the environment in which the a.exe in version 1.0, the b.exe in version 3.1, and the c.exe in version 1.5 operate (the client 2), it is defined such that the respective software is replaced so as to achieve an environment in which the a.exe in version 1.0.2, the b.exe in version 3.1, and the c.exe in version 1.5.1 operate.

It is also possible to separately define the software operating in conjunction with one another, with other configurations. For example, if software “d.exe” and “e.exe” operate in conjunction with one another, it is defined as configuration management information CIb.

Moreover, even if the same combination of software operates in conjunction with one another, when the combination of the version of the respective software differs, the configuration management information may be defined separately. Specifically, as is the case with the configuration defined by the configuration management information CIa, if the software, namely the “a.exe”, the “b.exe”, and the “c.exe” operate in conjunction with one another, when either one or both of the combination of the version of the respective software before the update, and the combination of the version of the respective software subjected to the update differs, in addition to the configuration management information CIa, for example, it may be defined as the configuration management information CIc.

The configuration management information is created by an operator, based on the software configuration for the environment that is quality guaranteed resulting from the operation verification and the software configuration for the environment, which serves as the update source, and is stored in the configuration-management-information storage 11. For example, the environment in which the combination of the version subjected to the update for the configuration management information CIa in FIG. 2, that is, the environment in which the combination of the a.exe in version 1.0.2, the b.exe in version 3.1; and the c.exe in version 1.5.1 operate together, corresponds to the software configuration for the environment that is quality guaranteed. Moreover, the environment in which the combination of the pre-update version for the configuration management information CIa, that is, the a.exe in version 1.0, the b.exe in version 3.1; and the c.exe in version 1.5 operate in conjunction with one another, is subject to the environment that is quality guaranteed. Note that the configuration-management-information storage 11 corresponds to the “configuration information storage part.”

When the configuration management information that will be newly registered and the installer for the software subjected to the update that is associated with the configuration management information are input by the operator, the distributed-software transmission part 10 stores the configuration management information in the configuration-management-information storage 11, and stores the installer in the distributed-software storage 12.

Moreover, after the distributed-software transmission part 10 receives from the distributed-software receiving part 21 of the client 2, with respect to the respective software operating at the client 2, requirements for verifying whether or not newly updated software are registered (hereinafter referred to as “verification requirements for the update software”), it determines whether the software subjected to the update is present at the client 2, and if the subjected software is present, it distributes the subjected software to the distributed-software receiving part 21 (the client 2 and the distributed-software receiving part 21 are described subsequently). The distributed-software transmission part 10 is described in detail below.

When the distributed-software transmission part 10 receives the verification requirements of the update software from the distributed-software receiving part 21, it first causes the distributed-software receiving part 21 to transmit a list of software identification information and the version of the respective software, with regard to the software installed to the client 2. At this time, the distributed-software transmission part 10 receives, from the distributed-software receiving part 21, the version of the respective software as the “pre-update version.”

Next, the distributed-software transmission part 10 compares the list of software identification information and the version of the respective software received from the distributed-software receiving part 21, to the list of software identification information and the pre-update version of the respective software defined in the respective configuration management information, which is stored in the configuration-management-information storage 11. If it detects that the list of software identification information and the version of the respective software received from the distributed-software receiving part 21 include the software configuration matching the configuration management information, the distributed-software transmission part 10 extracts the configuration management information corresponding to the software configuration that matches, from the configuration-management-information storage 11. For example, assume that the a.exe in version 1.0, the b.exe in version 3.1, the c.exe in version 1.5, and the d.exe in version 2.0 are installed to the client 2. In this case, the distributed-software transmission part 10 detects that the a.exe in version 1.0, the b.exe in version 3.1, and the c.exe in version 1.5 are installed, and extracts, the configuration management information CIa having the same definition as this combination of the pre-update version, from the configuration-management-information storage 11.

Next, the distributed-software transmission part 10, based on the pre-update version of the extracted configuration management information and the version subjected to the update, specifies the software to be distributed to the distributed-software receiving part 21 and extracts it from the distributed-software storage 12. For example, for cases of the configuration management information CIa in FIG. 2, the a.exe and the b.exe differ in the pre-update version and the version subjected to the update. Therefore, the distributed-software transmission part 10 extracts from the distributed-software storage 12, the installer for the a.exe in version 1.0.2 and the installer for the c.exe in version 1.5.1, which correspond to the version subjected to the update.

The distributed-software transmission part 10 transmits the installer for the respective software that is extracted from the distributed-software storage 12, together with the configuration management information that is extracted from the configuration-management-information storage 11, to the distributed-software receiving part 21. That is, for the case of the configuration management information CIa in FIG. 2, it transmits the installer for the a.exe in version 1.0.2, the installer for the c.exe in version 1.5.1, and the configuration management information CIa to the distributed-software receiving part 21. Note that hereinafter, the software subjected to the update from the configuration management information CIa (that is, the software that will be newly installed by the installer to be distributed to the distributed-software receiving part 21) are referred to as “software subjected to the update.”

Moreover, if the distributed-software transmission part 10 cannot extract the corresponding configuration management information, it does not perform processing regarding the extraction of the software from the distributed-software storage 12 and processing regarding the transmission of the extracted software and the configuration management information to the distributed-software storage 12.

Note that the distributed-software transmission part 10 may be constituted such that a list of the software identification information and the version of the respective software are regularly transmitted to the distributed-software receiving part 21. Accordingly, it is also possible for the distributed-software transmission part 10 to determine the configuration of the software installed to the client 2, and to distribute, as necessary, the installer for the software subjected to the update together with the corresponding configuration management information.

Moreover, it may be constituted such that the above-mentioned processing regarding the storage of the configuration management information to the configuration-management-information storage 11 and processing regarding the storage of the installer for the software subjected to the update to the distributed-software storage 12 are performed by providing a dedicated interface, which is different from the distributed-software transmission part 10, and have them performed by the interface. Note that in the present explanation, the explanation is provided assuming the above processing is performed by the distributed-software transmission part 10.

Next, the respective configuration of the client 2 is described in detail. Note that the client 2 corresponds to the “medical information processing device.”

The software execution part 20 runs the software installed to the client 2. The software execution part 20 is primarily known as a function of the OS (Operating System). For example, when a command is provided to execute the a.exe installed to the client 2, the program for the a.exe is run by the software execution part 20.

Moreover, when a command is provided so as to output the list of software installed, the software execution part 20 outputs the list of software installed to the client 2. At this time, the software execution part 20 may be constituted so as to, regarding the respective software, output at least the software identification information and the version.

Moreover, when a command is provided so as to output a list of the software being run, the software execution part 20 outputs the list of software being run on the client 2. At this time, the software execution part 20 may be constituted so as to, regarding the respective software, output at least the software identification information.

Moreover, when the software execution part 20 receives a command to stop the software that is being run, it stops the designated software that is being run. At this time, the software execution part 20 may be constituted such that it transmits the stop instruction to the software that received the command to stop it, or it may be constituted such that the software is forcibly stopped.

The distributed-software receiving part 21 transmits the verification requirements of the update software to the distributed-software transmission part 10 at a predefined timing (examples are described subsequently). For example, the distributed-software receiving part 21 may be constituted such that after it receives the command from the operator, it transmits the verification requirements of the update software to the distributed-software transmission part 10. Moreover, the distributed-software receiving part 21 may be constituted such that the verification requirement of the update software is transmitted regularly to the distributed-software transmission part 10.

Moreover, the distributed-software receiving part 21, after receiving a command from the distributed-software transmission part 10, acquires, from the software execution part 20, the software identification information and the version, regarding the respective software installed to the client 2, and transmits a list of acquired software identification information and the version of the respective software to the distributed-software transmission part 10.

Moreover, the distributed-software receiving part 21 receives the installer for the software subjected to the update and the configuration management information from the distributed-software transmission part 10. When it receives the installer for the software subjected to the update and the configuration management information, the distributed-software receiving part 21 first stores the received configuration management information to the disapproval-software-information storage 23. Next, the distributed-software receiving part 21 transmits the received installer for the software subjected to the update to the distributed-software updating part 22. At this time, the distributed-software receiving part 21 also notifies the distributed-software updating part 22 of the identification information for extracting the configuration management information stored in the disapproval-software-information storage 23. Note that the distributed-software receiving part 21 corresponds to the “acquisition part.”

When it receives the software subjected to the update and the identification information for identifying the configuration management information from the distributed-software receiving part 21, the distributed-software updating part 22 first starts up the disapproval-software detection part 24, and transmits the identification information received from the distributed-software receiving part 21 to the disapproval-software detection part 24 (the disapproval-software detection part 24 is described subsequently).

Next, the distributed-software updating part 22 runs the installer received from the distributed-software receiving part 21, and sequentially installs the software subjected to the update. Accordingly, the software corresponding to the pre-update version installed to the client 2 is replaced with the software corresponding to the version subjected to the update. Resulting from the execution of the received installer, when the installation for all of the software subjected to the update is complete, the distributed-software updating part 22 stops the detection by the disapproval-software detection part 24. Note that the distributed-software updating part 22 corresponds to the “updating part.”

The disapproval-software detection part 24, after receiving a command from the distributed-software updating part 22, monitors the action of the software defined in the configuration management information, and detects the software being run. For example, for cases in which among the software subjected to the update, some installation is complete while some installation is incomplete, the combination of the version of the respective software differs from the software configuration that is quality guaranteed. In such cases, when the software is executed, there are cases in which the software is not guaranteed to run properly and it is run incorrectly. In order to avoid situations like this, the disapproval-software detection part 24 monitors whether or not the software subjected to the update defined in the configuration management information, and the software operating in conjunction with the software subjected to the update are run. The action of the disapproval-software detection part 24 is described in detail below.

When it starts up after receiving a command from the distributed-software updating part 22, the disapproval-software detection part 24 first, based on the identification information received from the distributed-software updating part 22, extracts the configuration management information from the disapproval-software-information storage 23.

Next, the disapproval-software detection part 24 acquires, from the software execution part 20, a list of software identification information, regarding the software being run on the client 2, and compares it to the list of software identification information defined in the extracted configuration management information. As the disapproval-software detection part 24 detects that the list of the software identification information acquired from the software execution part 20 includes the software identification information defined in the configuration management information, it detects that the software corresponding to the software identification information is being run.

When it detects that the software corresponding to the software identification information defined in the configuration management information is being run, the disapproval-software detection part 24 transmits the software identification information corresponding to the software detected as being run to the disapproval-software suspending part 25 and the disapproval-software notifying part 26.

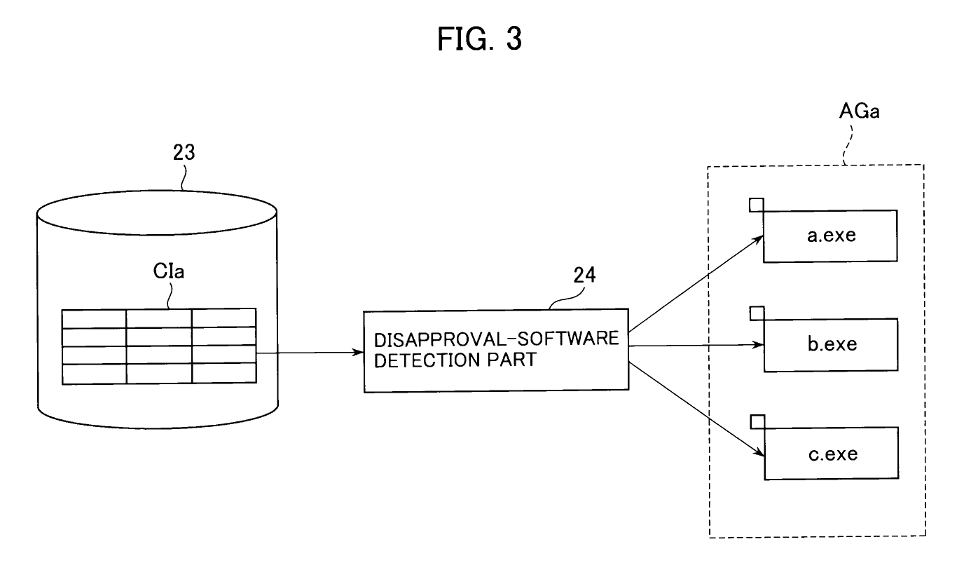

For example, FIG. 3 shows an example for cases in which the disapproval-software detection part 24 operates based on the configuration management information CIa in FIG. 2. In FIG. 3, the disapproval-software detection part 24, when operating based on the configuration management information CIa, monitors the action of the a.exe, the b.exe, and the c.exe defined in the configuration management information CIa. At this time, when the disapproval-software detection part 24 detects that either one of the a.exe, the b.exe, and the c.exe is being run, it notifies the disapproval-software suspending part 25 and the disapproval-software notifying part 26 of the software identification information corresponding to the detected software.

Until it is stopped by the distributed-software updating part 22, the disapproval-software detection part 24 executes processing regarding the monitoring of the action of the software defined in the abovementioned configuration management information and processing regarding the detection of the software being run, at each predefined interval, on a regular basis. For example, the disapproval-software detection part 24 may be constituted such that for each second, it executes processing regarding the detection of the software being run. Moreover, the disapproval-software detection part 24 may be constituted such that the interval to perform the processing can be changed. Note that the disapproval-software detection part 24 corresponds to the “determination part.”

When it receives the software identification information from the disapproval-software detection part 24, the disapproval-software suspending part 25 provides a command to stop the software corresponding to the software identification information. Note that the disapproval-software suspending part 25 corresponds to a “start-up controller.”

When it receives the software identification information from the disapproval-software detection part 24, the disapproval-software notifying part 26 notifies the operator of the client 2 that the software corresponding to the software identification information is being run. As the notification method, for example, a dialog box to which a message indicating that the software is being run is indicated may be displayed on a display or it may be constituted such that the message is recorded to the log. Moreover, it may be constituted such that after receiving the action of the disapproval-software suspending part 25, it notifies that the software is stopped.

Note that the disapproval-software detection part 24 may be constituted such that it receives the configuration management information from the distributed-software updating part 22. In this case, it is not necessary to provide the disapproval-software-information storage 23, and the distributed-software receiving part 21 may be constituted such that it transmits the configuration management information to the distributed-software updating part 22. Moreover, the distributed-software updating part 22 may be constituted such that it starts up the disapproval-software detection part 24 and transmits the configuration management information to the disapproval-software detection part 24 that started up.

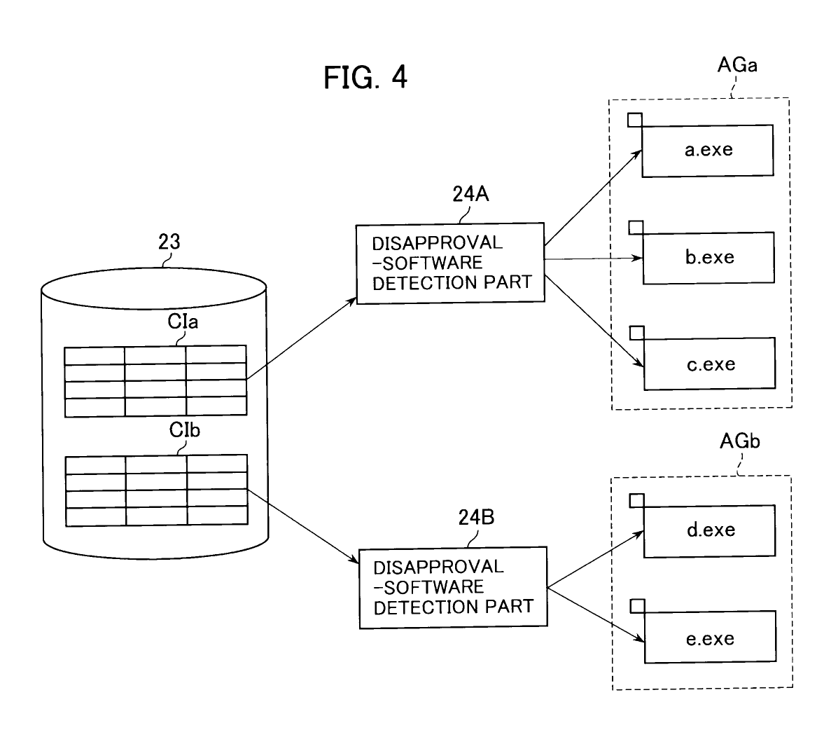

Moreover, in the above explanation, an explanation was provided for cases in which related software is installed, with respect to the software configuration based on one piece of configuration management information; however, it may be constituted such that the related software can be installed with respect to a plurality of software configurations. FIG. 4 is a figure for explaining the configuration for cases in which the disapproval-software detection part 24 monitors the action of the software, for cases in which the related software is installed with respect to the plurality of software configurations. When the related software is installed with respect to the plurality of software configurations, for example, as shown in FIG. 4, it may be constituted such that the disapproval-software detection part 24 starts up for each software configuration, corresponding to the respective configuration management information.

For example, in FIG. 4, when the a.exe, the b.exe, and the c.exe defined in the configuration management information CIa are replaced by the installer, based on the configuration management information CIa, a disapproval-software detection part 24A is started up. At this time, the disapproval-software detection part 24A monitors the action of the a.exe, the b.exe, and the c.exe being run on the client 2, as shown in AGa in FIG. 4. Moreover, when the d.exe and the e.exe defined in the configuration management information CIb are replaced by the installer, based on the configuration management information CIb, a disapproval-software detection part 24B is started up. At this time, the disapproval-software detection part 24B monitors the action of the d.exe and the e.exe being run on the client 2, as shown in AGb in FIG. 4.

Note that an explanation was provided above for the configuration in which after notification is received from the disapproval-software detection part 24, the disapproval-software notifying part 26 and the disapproval-software suspending part 25 operate; however, it may be constituted such that either one of the disapproval-software notifying part 26 and the disapproval-software suspending part 25 is operated.

(Processing)

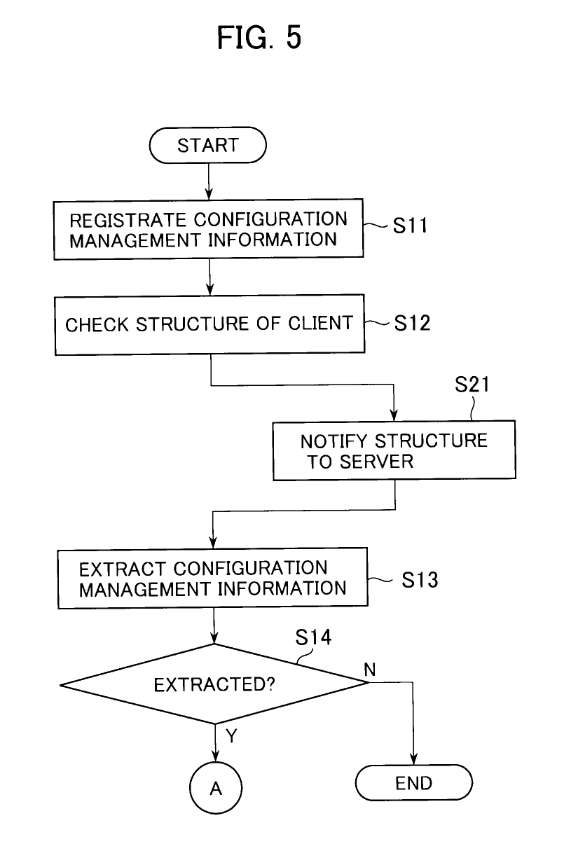

Next, processing of the software distributing system, according to the first embodiment is described with reference to FIG. 5 to FIG. 7. First, with reference to FIG. 5, an explanation is provided for processing the registration of the configuration management information and processing in which the distributed-software transmission part 10 verifies the software installed to the client 2 and in which it extracts the corresponding configuration management information. FIG. 5 is a flow chart explaining processing regarding the registration of the configuration management information and processing regarding the extraction of the configuration management information, based on the software configuration of the client 2.

(Step S11)

When the configuration management information created based on the environment that is quality guaranteed and the installer for the software subjected to the update associated with the configuration management information are input from the operator to the server 1, the distributed-software transmission part 10 causes the configuration management information to be stored in the configuration-management-information storage 11, and causes the installer to be stored in the distributed-software storage 12.

(Step S12)

Next, when the distributed-software transmission part 10 receives the verification requirements of the update software from the distributed-software receiving part 21 of the client 2, it causes the list of software identification information and the version of the respective software regarding the software installed to the client 2 to be transmitted to the distributed-software receiving part 21.

(Step S21)

The distributed-software receiving part 21, after receiving a command from the distributed-software transmission part 10, verifies the software installed to the client 2, and transmits the list of the software identification information and the version of the respective software to the distributed-software transmission part 10.

(Step S13)

Next, the distributed-software transmission part 10 compares the list of software identification information and the version of respective software received from the distributed-software receiving part 21, to the list of software identification information and the pre-update version of the respective software defined in the respective configuration management information, which is stored in the configuration-management-information storage 11. When it detects that the list of the software identification information and the version of the respective software received from the distributed-software receiving part 21 includes the software configuration matching the configuration management information, the distributed-software transmission part 10 extracts the configuration management information corresponding to the matched software configuration, from the configuration-management-information storage 11.

(Step S14)

If the corresponding configuration management information is not extracted from the configuration-management-information storage 11 (N at Step S14), the distributed-software transmission part 10 ends processing. If the corresponding configuration management information is extracted from the configuration-management-information storage 11 (Y at Step S14), the distributed-software transmission part 10 processes so as to distribute the installer for the software subjected to the update to the client 2.

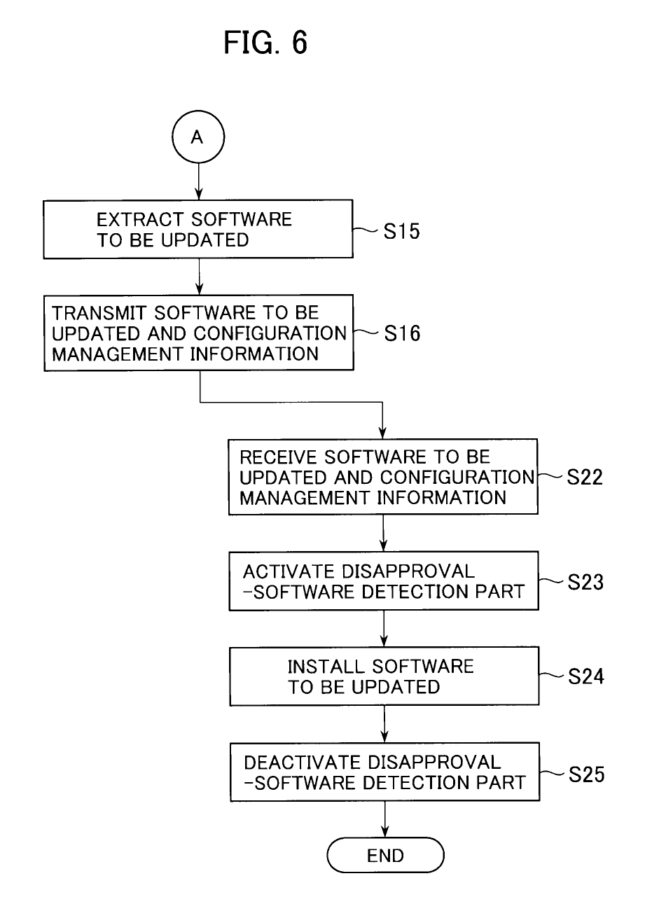

Next, with reference to FIG. 6, an explanation is provided regarding processing in which the distributed-software transmission part 10 distributes the installer for the software subjected to the update to the client 2 and in which the distributed-software updating part 22 installs the software subjected to the update by the installer. FIG. 6 is a flow chart for explaining processing to install the respective software to the client 2, based on the configuration management information.

(Step S15)

If the corresponding configuration management information is extracted from the configuration-management-information storage 11 (Y at Step S14 in FIG. 5), the distributed-software transmission part 10, based on the pre-update version and version subjected to the update for the extracted configuration management information, first specifies the software subjected to the update that will be distributed to the distributed-software receiving part 21. Next, the distributed-software transmission part 10 extracts the installer for the specified software subjected to the update, from the distributed-software storage 12.

(Step S16)

Next, the distributed-software transmission part 10 transmits the installer for the software subjected to the update extracted from the distributed-software storage 12 and the configuration management information extracted from the configuration-management-information storage 11 to the distributed-software receiving part 21.

(Step S22)

When it receives the installer for the software subjected to the update and the configuration management information from the distributed-software transmission part 10, the distributed-software receiving part 21 first stores the received configuration management information in the disapproval-software-information storage 23. Next, the distributed-software receiving part 21 transmits the received installer for the software subjected to the update to the distributed-software updating part 22. At this time, the distributed-software receiving part 21 also notifies the distributed-software updating part 22 of the identification information for extracting the configuration management information stored in the disapproval-software-information storage 23.

(Step S23)

When the distributed-software updating part 22 receives the identification information for identifying the software subjected to the update and the configuration management information from the distributed-software receiving part 21, it first starts up the disapproval-software detection part 24, and transmits this identification information received from the distributed-software receiving part 21 to the disapproval-software detection part 24. The action of the disapproval-software detection part 24 is described subsequently.

(Step S24)

Next, the distributed-software updating part 22 executes the installer received from the distributed-software receiving part 21 and installs the software subjected to the update sequentially.

(Step S25)

When the installation for all of the software subjected to the update is complete, resulting from the execution of the received installer, the distributed-software updating part 22 stops the disapproval-software detection part 24.

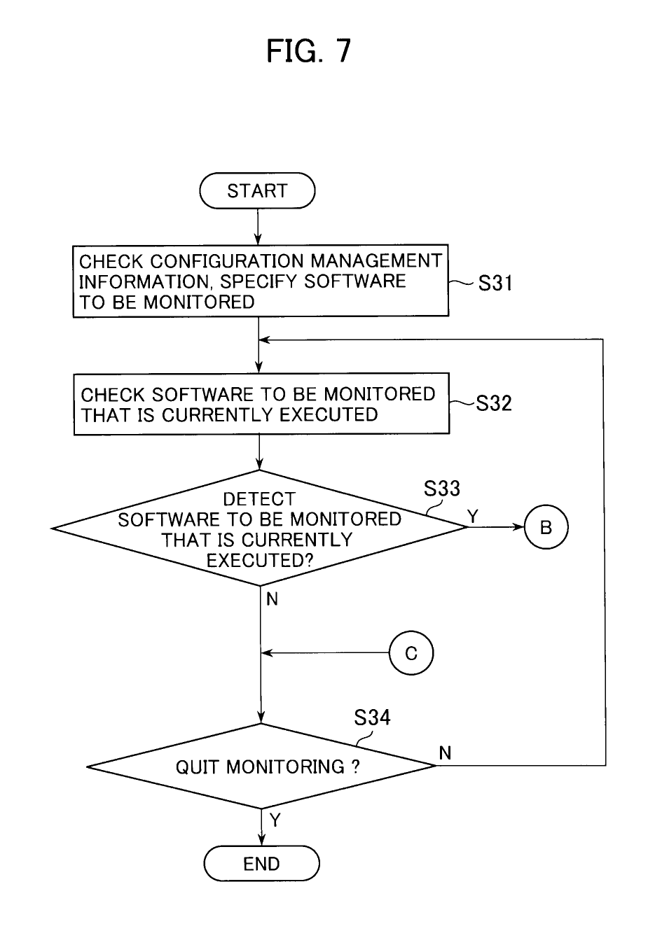

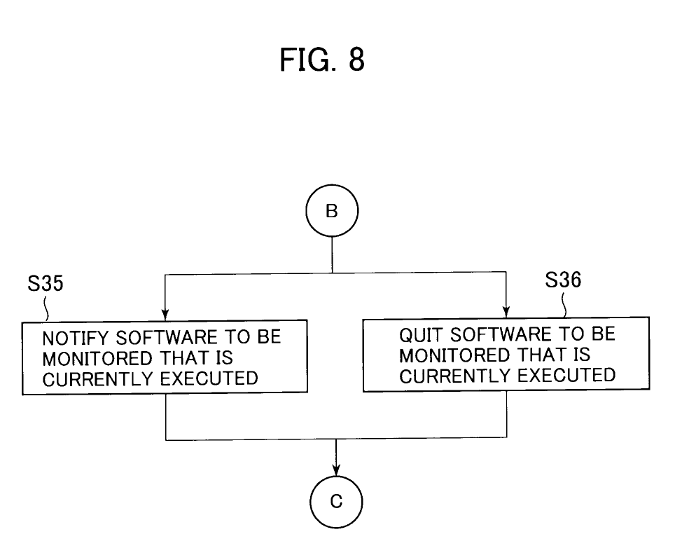

Next, with reference to FIG. 7 and FIG. 8, processing of the disapproval-software detection part 24 is described. FIG. 7 is a flow chart for explaining the action of the disapproval-software detection part 24. Moreover, FIG. 8 is a flow chart for explaining processing for cases in which the disapproval-software detection part 24 detects the action of the software subjected to the monitoring.

(Step S31)

When the disapproval-software detection part 24 starts up after receiving a command from the distributed-software updating part 22, based on the identification information received from the distributed-software updating part 22, it first extracts the configuration management information from the disapproval-software-information storage 23. The disapproval-software detection part 24 monitors the action of the software defined in the extracted configuration management information. The monitoring of the action of the software defined in the extracted the configuration management information by the disapproval-software detection part 24 is described in detail below.

(Step S32)

The disapproval-software detection part 24, first acquires a list of software identification information regarding the software run on the client 2, and compares it to the list of software identification information defined in the extracted configuration management information. As it verifies that the list of software identification information corresponding to the software run on the client 2 includes a software identifier defined in the configuration management information, the disapproval-software detection part 24 detects that the software defined in the configuration management information is being run.

(Step S33)

When it detects that the software corresponding to the software identification information defined in the configuration management information is being run (Y at Step S33), the disapproval-software detection part 24 transmits, to the disapproval-software suspending part 25 and the disapproval-software notifying part 26, the software identification information corresponding to the software that is detected as being run. If the software corresponding to the software identification information defined in the configuration management information is not being run (N at Step S33), the disapproval-software detection part 24 executes the following processing.

(Step S35)

FIG. 8 is referenced here. After receiving the software identification information from the disapproval-software detection part 24, the disapproval-software notifying part 26 notifies the operator of the client 2 that the software corresponding to the software identification information is being run.

(Step S36)

Moreover, after the disapproval-software suspending part 25 receives software identification information from the disapproval-software detection part 24, it provides the software execution part 20 with a command to stop the software corresponding to the software identification information. After receiving the command from the disapproval-software suspending part 25, the software execution part 20 stops the corresponding software that is being run.

Note that an explanation was provided above regarding the configuration in which after notification is received from the disapproval-software detection part 24, the disapproval-software notifying part 26 (Step S35) and the disapproval-software suspending part 25 (Step S36) operate; however, it may be constituted such that either one of the disapproval-software notifying part 26 or the disapproval-software suspending part 25 operates.

(Step S34)

FIG. 7 is referenced here. Until receiving a command to stop from the distributed-software updating part 22, the disapproval-software detection part 24 continues monitoring the action of the software defined in the configuration management information (N at Step S34). After receiving a command to stop from the distributed-software updating part 22 (Y at Step S34), the disapproval-software detection part 24 completes processing.

As above, according to the software distributing system according to the first embodiment, during installation of the software operating in conjunction with one another, the disapproval-software detection part 24 monitors the action of the respective software operating in conjunction with one another. Moreover, even for cases in which some of the installation of the respective software operating in conjunction with one another fails, until the installation completes properly with measures, such as running the installation again, the disapproval-software detection part 24 monitors the action of the respective software operating in conjunction with one another. Accordingly, with the software configuration different from the environment that is quality guaranteed, it is possible to control such that the respective software operating in conjunction with one another does not operate.

### Modified Example

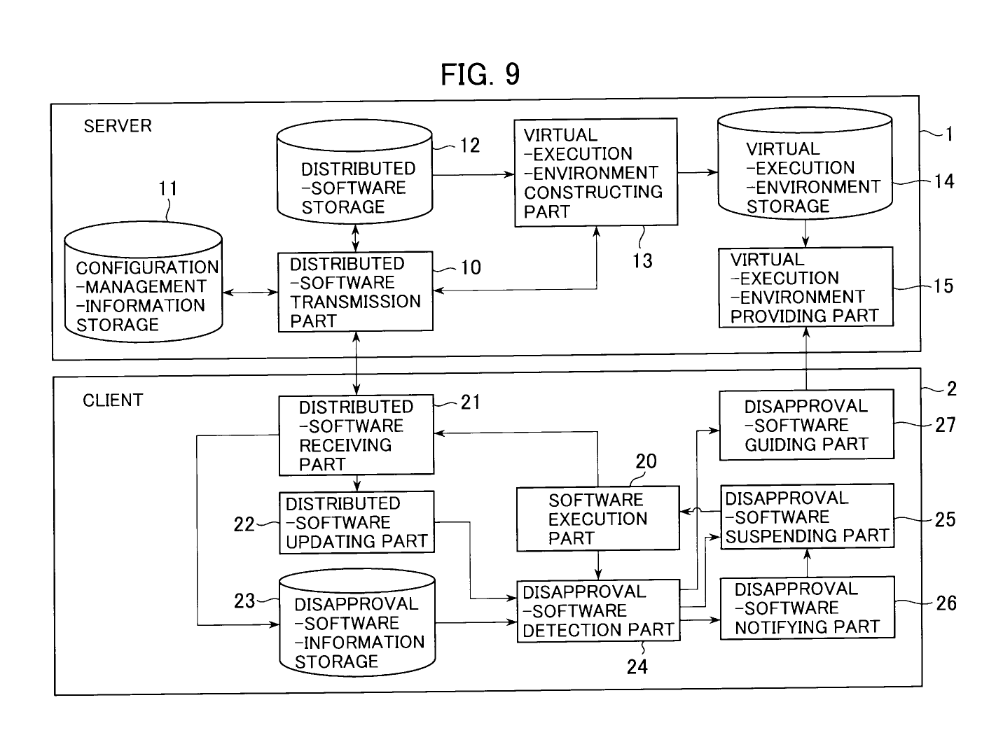

Next, the software distributing system according to the modified example is described. First, the configuration of the software distributing system according to the modified example is described with reference to FIG. 9. FIG. 9 is a function block diagram for the software distributing system according to the modified example.

The server 1 according to the modified example, in addition to the configuration of the server 1 according to the first embodiment, is further constituted from a virtual-execution-environment constructing part 13, virtual-execution-environment storage 14, and a virtual-execution-environment providing part 15. The configuration of the server 1 according to the modified example is described below, focusing on parts different from the configuration of the server 1 according to the first embodiment.

After receiving the configuration management information as an input, the virtual-execution-environment constructing part 13 creates a virtual environment in which the respective software defined in the configuration management information can operate. Specifically, the virtual-execution-environment constructing part 13 first creates an environment operating with a virtual OS on the basic OS operating on the server 1. The virtual OS is an OS that is logically configured on the basic OS and can be accessed from outside the server 1, as an environment different from the environment of the basic OS.

Next, from the distributed-software storage 12, the virtual-execution-environment constructing part 13 extracts the respective software that it is associated with in the configuration management information, and installs it on the created virtual OS. The virtual environment in which the respective software that it is associated within the configuration management information, is installed on the virtual OS and hereinafter referred to as a “virtual execution environment.” Moreover, the environment for the basic OS or the virtual OS in which the respective software is installed corresponds to a “virtual execution space.”

Next, the virtual-execution-environment constructing part 13 allocates connection destination information (address) to the created virtual execution environment in order to connect from outside the server 1 through a network. Specifically, as the virtual-execution-environment constructing part 13 designates the connection destination information, such that the created virtual execution environment can be operated through the network from the client 2, it adds the settings to the virtual OS constituting the virtual execution environment.

The virtual-execution-environment storage 14 is a memory area for selectively connecting the virtual execution environment created by the virtual-execution-environment constructing part 13, and managing as well as storing in order to be operated. The virtual-execution-environment constructing part 13 causes the created virtual execution environment to be associated with the connection destination information that is allocated to the virtual execution environment and stores it in the virtual-execution-environment storage 14. Accordingly, as the connection destination information is specified, it is possible to connect it to the virtual execution environment that is associated with the connection destination information and operate it. Specifically, the virtual OS constituting the virtual execution environment operates on the virtual-execution-environment storage 14. The operator accesses the virtual OS by specifying the connection destination information, making it possible to execute the respective software that it is associated with in configuration management information on the virtual OS.

After creating the virtual execution environment, the virtual-execution-environment constructing part 13 notifies the distributed-software transmission part 10 of the connection destination information that is associated with the virtual execution environment and the configuration management information used for extracting the respective software that is installed to the virtual execution environment.

When the configuration management information to be newly registered and the installer for the software subjected to the update, which is associated with the configuration management information, are input by the operator, the distributed-software transmission part 10 first causes the installer to be stored in the distributed-software storage 12. Next, the distributed-software transmission part 10 transmits the configuration management information to the virtual-execution-environment constructing part 13, in order to cause it to create the virtual execution environment.

After it receives the notification of the configuration management information and the connection destination information that is associated with the configuration management information from the virtual-execution-environment constructing part 13, the distributed-software transmission part 10 associates the configuration management information and the connection destination information.

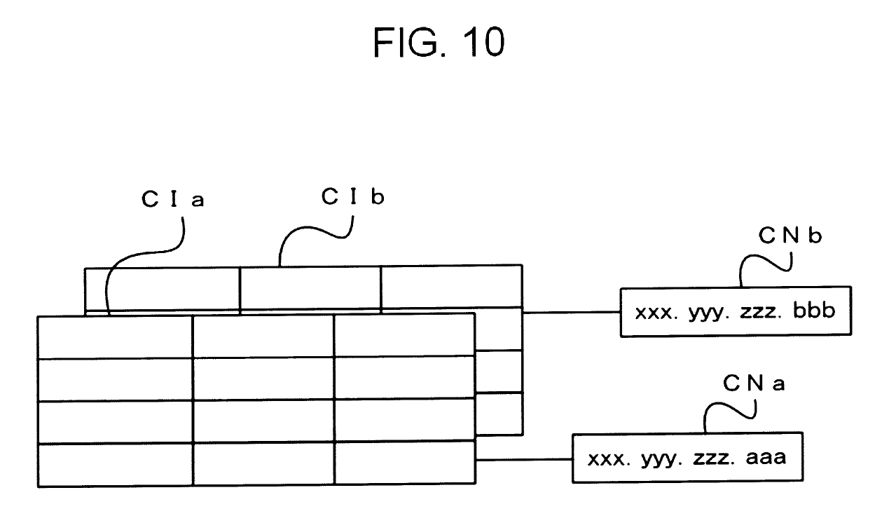

FIG. 10 is a figure explaining the association of the configuration management information with the connection destination information. For example, if the virtual-execution-environment storage 14 allocates connection destination information CNa to the virtual environment created based on the configuration management information CIa, the distributed-software transmission part 10 is notified of the configuration management information CIa and the connection destination information CNa from the virtual-execution-environment storage 14. At this time, the distributed-software transmission part 10 associates the configuration management information CIa with the connection destination information CNa. Similarly, if the virtual-execution-environment storage 14 allocates connection destination information CNb to the virtual environment created based on the configuration management information CIb, the distributed-software transmission part 10 associates the configuration management information CIb with the connection destination information CNb.

Note that the distributed-software transmission part 10 may be constituted such that the data in which the configuration management information is associated with the connection destination information is stored in the configuration-management-information storage 11. Moreover, it may be constituted such that by separately providing a management table, the association of the configuration management information with the connection destination information is managed. Hereinafter, explanations are provided, assuming that the data, in which the configuration management information is associated with the connection destination information, is stored in the configuration-management-information storage 11.

When receiving the verification requirements of the update software from the distributed-software receiving part 21, the distributed-software transmission part 10 first causes the distributed-software receiving part 21 to transmit the list of software identification information and the version of the respective software, regarding the software installed to the client 2, and extracts the corresponding configuration management information from the configuration-management-information storage 11. Next, the distributed-software transmission part 10, based on the pre-update version and the version subjected to the update for the extracted configuration management information, specifies the software subjected to the update, to be distributed to the distributed-software receiving part 21, and extracts the installer for the software subjected to the update from the distributed-software storage 12. The action is the same as the action for the distributed-software transmission part 10 according to the first embodiment.

Next, the distributed-software transmission part 10 transmits the installer for the software subjected to the update extracted from the distributed-software storage 12 and the configuration management information extracted from the configuration-management-information storage 11 to the distributed-software receiving part 21. At this time, the distributed-software transmission part 10 according to the modified example, along with the installer and the configuration management information, transmits the connection destination information associated with the configuration management information to the distributed-software receiving part 21. For example, when the configuration management information CIa shown in FIG. 10 is transmitted to the distributed-software receiving part 21, the connection destination information CNa associated with the configuration management information CIa is also transmitted to the distributed-software receiving part 21.

After the virtual-execution-environment providing part 15 receives the connection requirements along with the connection destination information from outside the server 1 via a network, it first specifies a virtual execution environment associated with the connection destination information, which is stored in the virtual-execution-environment storage 14. After specifying the virtual execution environment, the virtual-execution-environment providing part 15 establishes communications with the transmission source of the connection requirements, making it possible to operate the virtual execution environment specified from the transmission source of the connection requirements.

Next, the configuration of the client 2 according to the modified example is described. The client 2 according to the modified example, in addition to the configuration of the client 2 according to the first embodiment, is further constituted from a disapproval-software guiding part 27. The configuration of the client 2 according to the modified example is described below, focusing on parts different from the configuration of the client 2 according to the first embodiment.

First, for the distributed-software receiving part 21 according to the modified example, processing according to the transmission of the verification requirements of the update software and processing according to the transmission of the list of the software identification information installed to the client 2 and the version of the respective software are similar to those for the distributed-software receiving part 21 according to the first embodiment. Therefore, a detailed explanation is omitted.

The distributed-software receiving part 21, according to the modified example, receives from the distributed-software transmission part 10, in addition to the installer for the software subjected to the update and the configuration management information, further the connection destination information associated with the configuration management information.

The distributed-software receiving part 21 stores the received configuration management information to the disapproval-software-information storage 23. This action is similar to the action for the distributed-software receiving part 21 according to the first embodiment.

Next, the distributed-software receiving part 21 transmits the received installer for the software subjected to the update to the distributed-software updating part 22. At this time, the distributed-software receiving part 21 notifies the distributed-software updating part 22 of identification information for extracting the configuration management information stored in the disapproval-software-information storage 23 and the received connection destination information together with the installer.

After the distributed-software updating part 22 receives the software subjected to the update, the identification information for identifying the configuration management information, and the connection destination information, it first causes the disapproval-software detection part 24 to start up, and transmits the identification information and the connection destination information received from the distributed-software receiving part 21 to the disapproval-software detection part 24.

Next, the distributed-software updating part 22 runs the installer received from the distributed-software receiving part 21 and sequentially installs the software subjected to the update. As a result of the execution of the received installer, when installation for all of the software subjected to the update is complete, the distributed-software updating part 22 stops the disapproval-software detection part 24.

After the disapproval-software detection part 24 receives a command from the distributed-software updating part 22, it monitors the action of the software defined in the configuration management information and detects the software that is being run. This action is similar to the action for the disapproval-software detection part 24 according to the first embodiment.

If the disapproval-software detection part 24 according to the modified example detects that the software corresponding to the software identification information defined in the configuration management information is being run, it transmits the software identification information corresponding to the software detecting that it is being run, to the disapproval-software suspending part 25 and the disapproval-software notifying part 26. Moreover, at this time, the disapproval-software detection part 24 according to the modified example transmits the connection destination information notified from the distributed-software updating part 22, to the disapproval-software guiding part 27.

After the disapproval-software guiding part 27 receives the connection destination information from the disapproval-software detection part 24, it transmits the connection requirements together with the connection destination information to the virtual-execution-environment providing part 15. Upon receiving the connection requirements, the virtual-execution-environment providing part 15 establishes a connection with the virtual execution environment to which the connection information is allocated. Accordingly, the operator, even if it is not possible to operate the software subjected to the update on the client 2, can use the software subjected to the update installed in the virtual execution environment to operate it. Note that the disapproval-software guiding part 27 corresponds to the “controller.”

Note that an explanation was provided above regarding the configuration in which, after receiving notification from the disapproval-software detection part 24, the disapproval-software notifying part 26, the disapproval-software suspending part 25, and the disapproval-software guiding part 27 operate; however, it may be constituted such that any one or two of the disapproval-software notifying part 26, the disapproval-software suspending part 25, and the disapproval-software guiding part 27 operate.

(Processing)

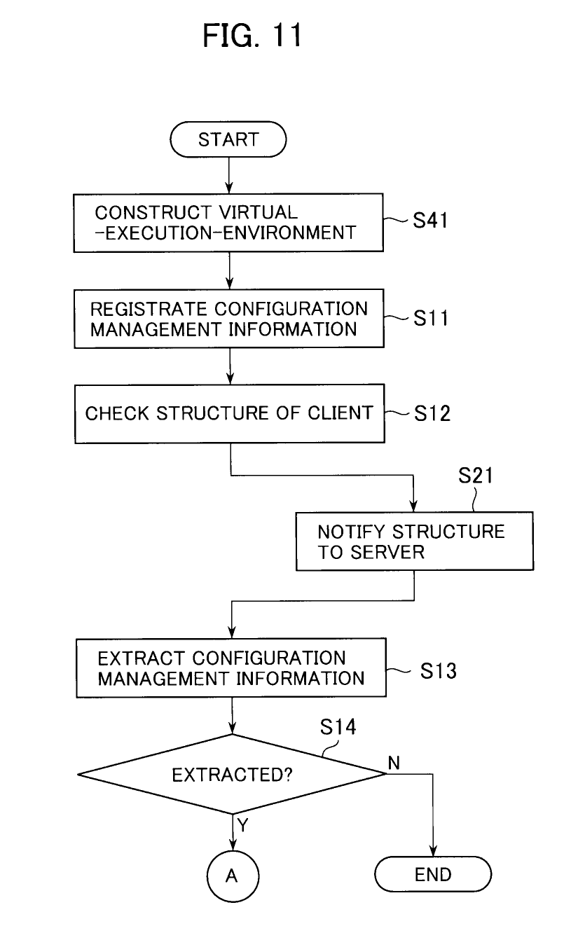

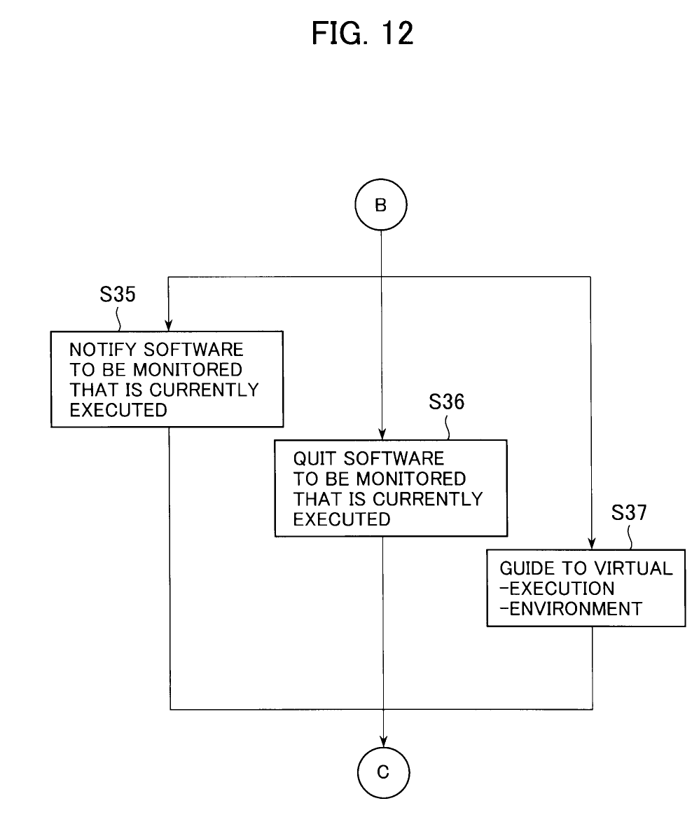

Next, processing of the software distributing system according to the modified example is described with reference to FIG. 6, FIG. 7, FIG. 11, and FIG. 12. First, with reference to FIG. 11, an explanation is provided for processing regarding the registration of the configuration management information up to processing in which the distributed-software transmission part 10 verifies the software installed to the client 2 and extracts the corresponding configuration management information, focusing on parts different from the software distributing system according to the first embodiment. FIG. 11 is a flow chart explaining the process regarding the registration of the configuration management information and the process regarding the extraction of the configuration management information, based on the software configuration of the client 2.

(Step S41)

When the configuration management information created based on the environment that is quality guaranteed and the installer for the software subjected to the update associated with the configuration management information are input by the operator to the server 1, the distributed-software transmission part 10 first stores the installer in the distributed-software storage 12. Next, the distributed-software transmission part 10 transmits the configuration management information to the virtual-execution-environment constructing part 13 and causes the virtual execution environment to be created.

The virtual-execution-environment constructing part 13 receives the configuration management information as an input and creates a virtual execution environment in which the respective software defined in the configuration management information can operate. Next, the virtual-execution-environment constructing part 13 allocates the connection destination information to the created virtual execution environment in order to connect from outside the server 1 through the network. The virtual-execution-environment constructing part 13 associates the created virtual execution environment with the connection destination information that is allocated to the virtual execution environment and stores them in the virtual-execution-environment storage 14.

After the virtual-execution-environment constructing part 13 creates the virtual execution environment, it notifies the distributed-software transmission part 10 of the connection destination information associated with the virtual execution environment and the configuration management information used for extracting the respective software installed to the virtual execution environment.

(Step S11)

After the distributed-software transmission part 10 is notified of the configuration management information and the connection destination information associated with the configuration management information, from the virtual-execution-environment constructing part 13, it associates the configuration management information with the connection destination information and stores them in the configuration-management-information storage 11.

(Step S12 and Step S21)

Processing according to Step S12 and Step S21 is similar to processing for the software system according to the first embodiment. After the distributed-software transmission part 10 receives the verification requirements of the update software from the distributed-software receiving part 21, it causes the distributed-software receiving part 21 to transmit the list of the software identification information and the version of the respective software, regarding the software installed to the client 2.

(Step S13)

Next, the distributed-software transmission part 10 compares the list of software identification information and the version of the respective software received from the distributed-software receiving part 21, to contents of the respective configuration management information stored in the configuration-management-information storage 11, and extracts the corresponding configuration management information from the configuration-management-information storage 11. At this time, the distributed-software transmission part 10, together with the configuration management information, extracts the connection destination information associated with the configuration management information.

(Step S14)

If the corresponding configuration management information is not extracted from the configuration-management-information storage 11 (N at Step S14), the distributed-software transmission part 10 ends processing. If the corresponding configuration management information is extracted from the configuration-management-information storage 11 (Y at Step S14), the distributed-software transmission part 10 distributes the installer for the software subjected to the update to the client 2.

Next, with reference to FIG. 6, an explanation is provided regarding processing in which the distributed-software transmission part 10 distributes the installer for the software subjected to the update on the client 2 and in which the distributed-software updating part 22 installs the software subjected to the update with the installer, focusing on parts different from the software distributing system according to the first embodiment. FIG. 6 is a flow chart explaining the process to install the respective software to the client 2, based on the configuration management information.

(Step S15)

If the corresponding configuration management information is extracted from the configuration-management-information storage 11 (Y at Step S14 in FIG. 5), the distributed-software transmission part 10, based on the configuration management information, extracts the installer for the software subjected to the update from the distributed-software storage 12. This processing is similar to the processing for the software distributing system according to the first embodiment.

(Step S16)

Next, the distributed-software transmission part 10 transmits the installer for the software subjected to the update extracted from the distributed-software storage 12, and the configuration management information and the connection destination information extracted from the configuration-management-information storage 11 to the distributed-software receiving part 21.

(Step S22)

When the distributed-software receiving part 21 receives the installer for the software subjected to the update, the configuration management information, and the connection destination information from the distributed-software transmission part 10, it first stores the received configuration management information to the disapproval-software-information storage 23.

Next, the distributed-software receiving part 21 transmits the received installer for the software subjected to the update to the distributed-software updating part 22. At this time, the distributed-software receiving part 21 also notifies the distributed-software updating part 22 of the identification information for extracting the configuration management information stored in the disapproval-software-information storage 23 and the received connection destination information.

(Step S23)

When the distributed-software updating part 22 receives the software subjected to the update, the identification information for identifying the configuration management information, and the connection destination information from the distributed-software receiving part 21, it first starts the disapproval-software detection part 24 and transmits the identification information and the connection destination information received from the distributed-software receiving part 21 to the disapproval-software detection part 24.

Hereinafter, as a result of processing according to Step S24, the installation is started by executing the installer for the software subjected to the update, and as a result of processing according to Step S25 after the completion of installation of the software subjected to the update, the disapproval-software detection part 24 is stopped. This processing according to Step S24 and Step S25 is similar to the processing for the software distributing system according to the first embodiment.

Next, with reference to FIG. 7 and FIG. 12, processing of the disapproval-software detection part 24 is described, focusing on parts different from the software distributing system according to the first embodiment. FIG. 7 is a flow chart explaining the action of the disapproval-software detection part 24. Moreover, FIG. 12 is a flow chart explaining the process by which the disapproval-software detection part 24 detects the action of the software subjected to the monitoring.

The disapproval-software detection part 24 according to the modified example starts after receiving a command from the distributed-software updating part 22, and receives the identification information for identifying the configuration management information and the connection destination information, from the distributed-software updating part 22.

Processing according to Step S31 and Step S32 is similar to the processing for the software distributing system according to the first embodiment. That is, the disapproval-software detection part 24, based on the identification information received from the distributed-software updating part 22, extracts the configuration management information from the disapproval-software-information storage 23. Next, the disapproval-software detection part 24 verifies whether the software defined in the extracted configuration management information is being executed at the client 2.

(Step S33)

When it detects that the software corresponding to the software identification information defined in the configuration management information is being run (Y at Step S33), the disapproval-software detection part 24 transmits the software identification information corresponding to the software that is detected as being run to the disapproval-software suspending part 25 and the disapproval-software notifying part 26. Moreover, the disapproval-software detection part 24 transmits the connection destination information notified from the distributed-software updating part 22 to the disapproval-software guiding part 27.

(Step S35)

FIG. 12 is referenced here. After receiving the software identification information from the disapproval-software detection part 24, the disapproval-software notifying part 26 notifies the operator of the client 2 that the software corresponding to the software identification information is being run.

(Step S36)

Moreover, after the disapproval-software suspending part 25 receives the software identification information from the disapproval-software detection part 24, it commands the software execution part 20 to stop the software corresponding to the software identification information. After receiving the command from the disapproval-software suspending part 25, the software execution part 20 stops the corresponding software that is being run. Processing according to Step S35 and Step S36 is similar to processing for the software distributing system according to the first embodiment.

(Step S37)

Moreover, the disapproval-software guiding part 27 transmits the connection destination information received from the disapproval-software detection part 24, together with the connection requirements, to the virtual-execution-environment providing part 15. After the virtual-execution-environment providing part 15 receives the connection requirements, together with the connection destination information, from the disapproval-software guiding part 27, it first specifies the virtual execution environment that is associated with the connection destination information from the virtual-execution-environment storage 14. After specifying the virtual execution environment, the virtual-execution-environment providing part 15 establishes communication with the client 2, making it possible to operate the virtual execution environment specified from the client 2, which is the transmission source of the connection requirements.

Note that an explanation was provided above regarding the configuration in which, after notification is received from the disapproval-software detection part 24, the disapproval-software notifying part 26 (Step S35), the disapproval-software suspending part 25 (Step S36), and the disapproval-software guiding part 27 (Step S37) operate; however, it may be constituted such that any one or two of the disapproval-software notifying part 26, the disapproval-software suspending part 25, and the disapproval-software guiding part 27 operates.

(Step S34)

FIG. 7 is referenced here. Until receiving a command to stop from the distributed-software updating part 22, the disapproval-software detection part 24 continues monitoring the action of the software defined in the configuration management information (N at Step S34). Once receiving a command to stop from the distributed-software updating part 22 (Y at Step S34), the disapproval-software detection part 24 completes processing.

Note that the virtual-execution-environment providing part 15 may be constituted such that after it receives the configuration management information instead of the connection destination information from the disapproval-software guiding part 27, and after it specifies the virtual execution environment created based on the configuration management information, it establishes a connection between the specified virtual execution environment and the client 2. When this configuration is used, the distributed-software transmission part 10 may not have to transmit the connection destination information to the distributed-software receiving part 21.

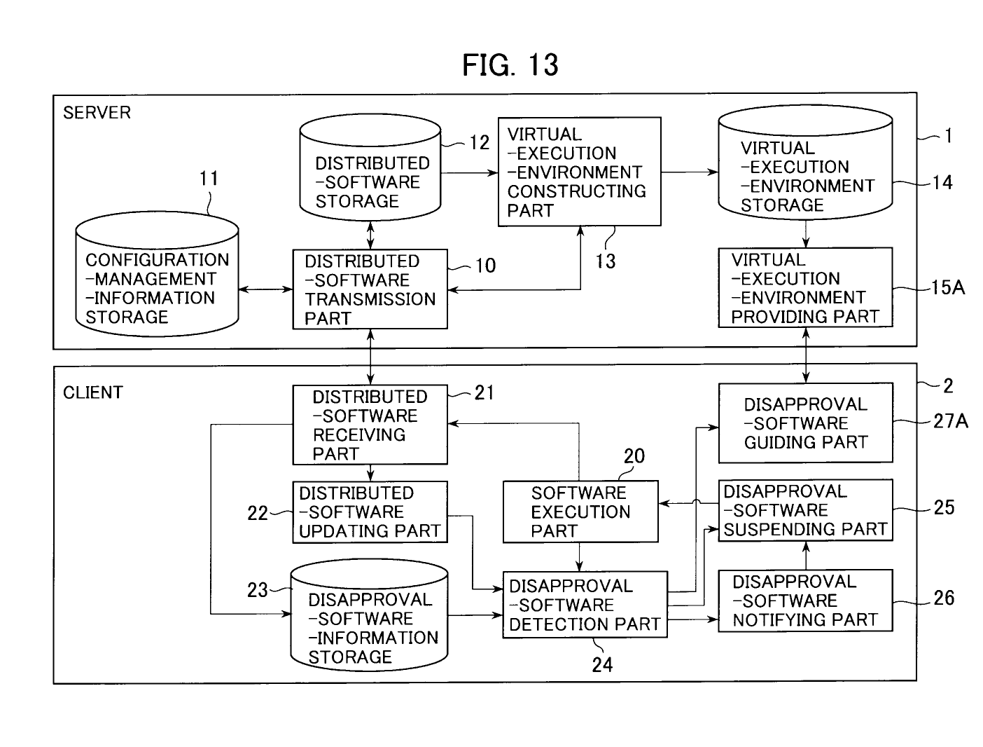

Moreover, it may be constituted such that the virtual execution environment is deployed on the client 2 in order to run this virtual execution environment so as to be operational. FIG. 13 is a block diagram showing one example causing it to operate with such aspects.

With such aspects, a disapproval-software guiding part 27A transmits the connection destination information to a virtual-execution-environment providing part 15A, and provides a command to the virtual-execution-environment providing part 15A to output the virtual execution environment corresponding to this connection destination information.

The virtual-execution-environment providing part 15A extracts the virtual execution environment corresponding to the received connection destination information from the virtual-execution-environment storage 14 and outputs the extracted virtual execution environment to the disapproval-software guiding part 27A.

The disapproval-software guiding part 27A deploys the virtual execution environment received from the virtual-execution-environment providing part 15A on the client 2 and the operator operates it so as to be operational. Accordingly, it is possible for the operator to log in to the virtual execution environment operating on the client 2 and perform operations, using the software subjected to the update.

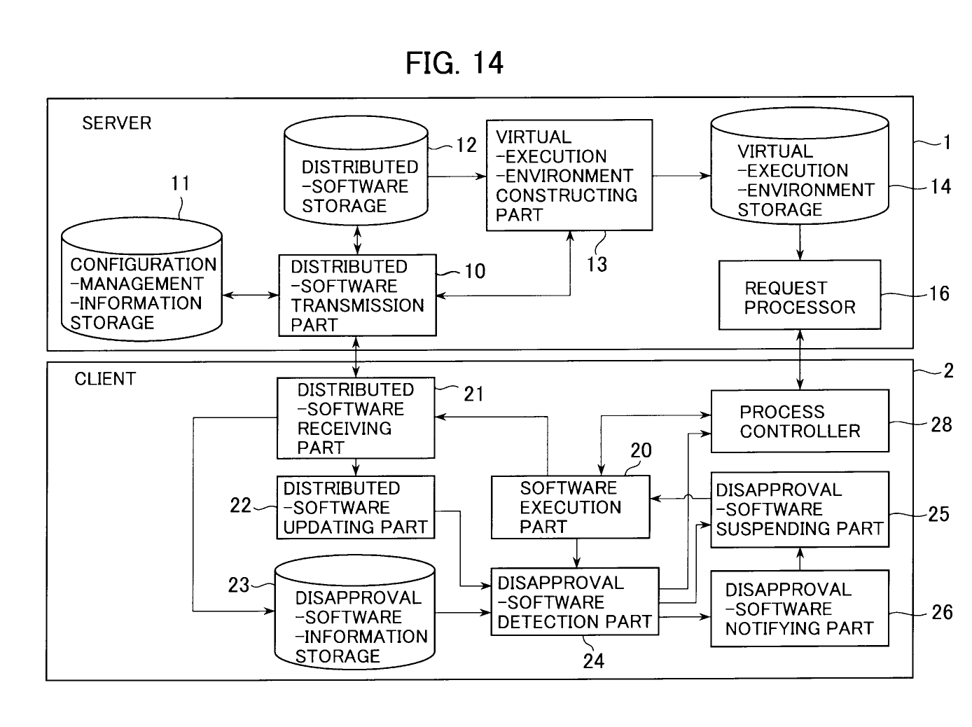

Moreover, it may be constituted such that instead of the guidance to the virtual execution environment, processing by the software subjected to the update is requested to the server 1, and the processing results are received at the client 2. FIG. 14 is a block diagram showing one example for causing it to operate with such aspects. In such cases, as shown in FIG. 14, instead of the virtual-execution-environment providing part 15, a request processor 16 is provided. Moreover, instead of the disapproval-software guiding part 27A, a process controller 28 is provided.

In this aspect, after receiving detection from the disapproval-software detection part 24, the process controller 28, based on the information according to the software subjected to the execution, requests the request processor 16 to perform processing of that software on its behalf. In this case, the process controller 28, for example, after receiving the configuration management information from the disapproval-software detection part 24, may specify the type of the software for which a request is to be made to the request processor 16 regarding the processing on its behalf. Moreover, the process controller 28 may receive a processing parameter for executing this software, from the software execution part 20. The process controller 28 may notify the request processor 16 of this processing parameter, upon request. Note that when the process controller 28 requests the request processor 16 to perform the processing on its behalf, it also notifies the configuration management information.

The request processor 16 receives the request regarding performing the processing on behalf of the process controller 28, along with the configuration management information, from the process controller 28. After receiving this request, the process controller 28 specifies the virtual execution environment corresponding to the received configuration management information from the virtual-execution-environment storage 14. The process controller 28 executes processing requested in the specified virtual execution environment and notifies the process controller 28 of the results. As a result of this type of configuration, it is possible for the process controller 28 to have the server 1 execute processing with the software subjected to the update.

As above, based on the software distributing system according to the modified example, in addition to the characteristics of the software distributing system according to the first embodiment, even if it is not possible to use the software, resulting from the monitoring by the disapproval-software detection part 24, it is possible to use the software installed to the virtual execution environment as a substitution environment. Accordingly, even if it is not possible to operate using the software at the client 2, the operator is able to perform the operation, using the virtual execution environment.

While certain embodiments have been described, these embodiments have been presented by way of example only, and are not intended to limit the scope of the inventions. Indeed, the novel systems described herein may be embodied in a variety of their forms; furthermore, various omissions, substitutions and changes in the form of the systems described herein may be made without departing from the spirit of the inventions. The accompanying claims and their equivalents are intended to cover such forms or modifications as would fall within the scope and spirit of the inventions.

What is claimed is:

1. A medical information processing device, comprising:
a storage part that stores a plurality of application programs;
a configuration information storage part to which configuration information for an execution environment that is quality guaranteed, corresponding to said application program, is stored;
a determination part that, based on said configuration information, determines whether it is possible to run said application program; and
a controller that, if it is determined by said determination part that said application program cannot be run, causes a function corresponding to said application program to be run on a server;

2. A medical information processing device, comprising:
a storage part that stores a plurality of application programs;
a configuration information storage part to which configuration information for an execution environment that is quality guaranteed, corresponding to said application program, is stored;
a determination part that, based on said configuration information, determines whether it is possible to run said application program; and
a controller that, if it is determined at said determination part that said application program cannot be run, causes said application program to be run in a virtual execution space, which is different from the virtual execution space running said application program.

3. The medical information processing device according to claim 1; wherein the configuration information of said execution environment includes information identifying types of related application program, necessary for the execution of said application program.

4. The medical information processing device according to claim 1; wherein the configuration information of said execution environment includes version information of related application program, necessary for the execution of said application program.

5. A medical information processing device, comprising:
a storage part that stores a plurality of application programs;
an acquisition part that acquires an installation program for updating said application program through a network from a server;
an updating part that updates said application program by running said installation program;
a configuration information storage part to which configuration information for an execution environment that is quality guaranteed, corresponding to said application program, is stored;
a determination part that, based on said configuration information, determines whether it is possible to run said application program; and
a start-up controller that, if it is determined by said determination part that said application program cannot be run, prohibits the execution of this application program.

6. The medical information processing device according to claim 5, comprising a controller that causes a function corresponding to said application programs that is prohibited from being run, to be run through a network on a server.

7. A medical information processing device, comprising:
a storage part that stores a plurality of application programs;
a configuration information storage part to which configuration information for an execution environment including information of related application program that is related to the execution of said application programs, is stored;
a determination part that, based on said configuration information, determines whether a related application program necessary for the execution of said application programs is present; and
a controller that, if it is determined by said determination part that said related application program is not present, causes a function corresponding to this related application program to be run through a network on a server.

8. A medical information processing device, comprising:
a storage part that stores a plurality of application programs;
an acquisition part that acquires an installation program for updating said application program through a network from a server;
an updating part that updates said application program by running said installation program;
a configuration information storage part to which said application programs and related application programs that are related to the execution of said application programs are stored by being associated with each other;
a program start-up controller that, when said application programs are updated, prohibits the execution of said related application programs that are associated with the application programs subjected to the update.

9. The medical information processing device according to claim 8, comprising a controller that causes a function corresponding to said related application programs that are prohibited from being run, to be run through a network on a server.

10. A software distributing system comprising a plurality of terminals; and a server that distributes software to said terminals,
said server comprising:
a storage part that stores a plurality of application programs; and
a configuration information storage part to which configuration information for an execution environment that is quality guaranteed, corresponding to said application program, is stored;
and said terminals comprising:
an acquisition part that acquires an installation program for updating said application program; and said configuration information corresponding to said application program, through a network from said server;
a determination part that, based on said configuration information, determines whether it is possible to run said application program; and
a controller that, if it is determined by said determination part that said application program cannot be run, causes a function corresponding to this application program to be run on the server.
